(19) United States
(12) Patent Application Publication
(10) Pub. No.: US 2025/0243105 A1
(43) Pub. Date: Jul. 31, 2025

(54) METHOD FOR MANUFACTURING MOLDED ARTICLE

(71) Applicant: DISCO CORPORATION, Tokyo (JP)

(72) Inventors: Naoki MURAZAWA, Tokyo (JP); Tsubasa HIROSE, Tokyo (JP); Haruna YANO, Tokyo (JP)

(21) Appl. No.: 19/009,359

(22) Filed: Jan. 3, 2025

(30) Foreign Application Priority Data
Jan. 26, 2024 (JP) 2024-010429

(51) Int. Cl. C03B 33/02; C03B 33/04

(52) U.S. Cl. CPC C03B 33/0222; C03B 33/04

(57) ABSTRACT

A method for manufacturing a molded article having a desired shape from a workpiece includes: forming a shield tunnel including a pore extending from a surface of the workpiece to a predetermined depth in a thickness direction and a modified region surrounding the pore by positioning a concentration region of a first laser beam inside the workpiece and irradiating the workpiece with the first laser beam along the desired shape; forming a separation layer including a modified portion parallel to the first surface and a crack extending from the modified portion by positioning a concentration point of a second laser beam at a depth corresponding to a thickness of the molded article, relatively moving the concentration point and the workpiece, and irradiating the workpiece with the second laser beam; separating the workpiece into first and second workpieces; and dividing the molded article from the first workpiece along the shield tunnel.

### CROSS-REFERENCE TO RELATED APPLICATION(S)

The present application claims priority to and incorporates by reference the entire contents of Japanese Patent Application No. 2024-010429 filed in Japan on Jan. 26, 2024.

### BACKGROUND

The present disclosure relates to a method for manufacturing a molded article.

In recent years, with diversification of designs of mobile devices, a display panel having a shape other than a rectangle or a display panel having a curved surface has appeared. In accordance with the diversification of the shape of the display panel, the shape of a material used for a housing has been also diversified. In addition, there is a demand for cutting out the material in various shapes such as cover glass and optical components for protecting a camera mounted on a smartphone.

However, many materials used in the above-described applications are known as hard and brittle difficult-to-process materials such as glass, quartz, and silicon carbide (SiC), and are not easy to process into a desired shape. Therefore, there has been proposed a method of irradiating such a material with a laser beam to form a modified region called a shield tunnel having pores and a denatured region surrounding the pores, and manufacturing a molded article having a desired shape (see JP 2020-132476 A and JP 2020-110830 A).

In the above method, a molded article having a fine shape can be manufactured, but each substrate is required to be irradiated with a laser beam to be molded into a desired shape, and there is a problem that the manufacturing takes time.

### SUMMARY

A method according to one aspect of the present disclosure is for manufacturing a molded article to obtain the molded article having a desired shape from a workpiece having a first surface and a second surface opposite to the first surface. The method includes: forming, along the desired shape, a shield tunnel including a pore extending from the first surface of the workpiece to a predetermined depth in a thickness direction of the workpiece and a modified region surrounding the pore by positioning a concentration region of a first laser beam having a wavelength transmissive to the workpiece inside the workpiece and irradiating the workpiece with the first laser beam along the desired shape; forming a separation layer including a modified portion parallel to the first surface and a crack extending from the modified portion by positioning a concentration point of a second laser beam having a wavelength transmissive to the workpiece at a depth corresponding to a thickness of the molded article to be manufactured from the first surface, relatively moving the concentration point and the workpiece, and irradiating the workpiece with the second laser beam; separating the workpiece into a first workpiece having the first surface and a second workpiece having the second surface with the separation layer as a start point after the forming the shield tunnel and the forming the separation layer; and dividing the molded article from the first workpiece along the shield tunnel formed along the desired shape by performing predetermined processing on the first workpiece.

### BRIEF DESCRIPTION OF THE DRAWINGS

FIG. 1 is a perspective view of a workpiece to be processed by a method for manufacturing a molded article according to an embodiment;

FIG. 2 is a side view of the workpiece illustrated in FIG. 1;

FIG. 3 is a flowchart illustrating a flow of the method for manufacturing a molded article according to the embodiment;

FIG. 4 is a perspective view illustrating a state of a shield tunnel formation step illustrated in FIG. 3;

FIG. 5 is an enlarged sectional view illustrating a part of the workpiece after FIG. 4;

FIG. 6 is a perspective view schematically illustrating a structure of a shield tunnel;

FIG. 7 is a sectional view for describing a procedure of forming a plurality of layers of shield tunnels;

FIG. 8 is a sectional view illustrating an example of an interlayer of the plurality of layers of shield tunnels;

FIG. 9 is a sectional view illustrating another example of the interlayer of the plurality of layers of shield tunnels;

FIG. 10 is a top view of the workpiece for describing a division auxiliary line setting step and a division auxiliary start point formation step;

FIG. 11 is a perspective view illustrating a state of a separation layer formation step illustrated in FIG. 3;

FIG. 12 is a side view illustrating a state of the separation layer formation step illustrated in FIG. 3 in a partial cross section;

FIG. 13 is a top view of the workpiece in FIGS. 11 and 12;

FIG. 14 is a side view illustrating a state of a separation step illustrated in FIG. 3;

FIG. 15 is a side view illustrating a state of the separation step illustrated in FIG. 3;

FIG. 16 is a side view illustrating a state of a flattening step illustrated in FIG. 3 in a partial cross section;

FIG. 17 is a side view illustrating a state of the flattening step illustrated in FIG. 3 in a partial cross section;

FIG. 18 is a side view illustrating a state of a first example of a division step illustrated in FIG. 3 in a partial cross section;

FIG. 19 is a side view illustrating the state of the first example of the division step illustrated in FIG. 3 in a partial cross section;

FIG. 20 is a side view illustrating a state of a second example of the division step illustrated in FIG. 3 in a partial cross section;

FIG. 21 is a side view illustrating the state of the second example of the division step illustrated in FIG. 3 in a partial cross section;

FIG. 22 is a sectional view of the workpiece for describing a shield tunnel formation step according to a first modification;

FIG. 23 is a flowchart illustrating a flow of a shield tunnel formation step according to a second modification; and

FIG. 24 is a sectional view of the workpiece for describing the shield tunnel formation step according to the second modification.

### DETAILED DESCRIPTION

A preferred embodiment (embodiment) for carrying out the present disclosure will be described in detail with reference to the drawings. The present invention is not limited by the contents described in the following embodiment. The constituent elements described below include elements that can be easily assumed by those skilled in the art and elements that are substantially the same. Furthermore, the configurations described below can be appropriately combined. In addition, various omissions, substitutions, or changes in the configurations can be made without departing from the gist of the present invention.

### Embodiment

A method for manufacturing a molded article 21 according to an embodiment of the present disclosure will be described with reference to the drawings. The method for manufacturing the molded article 21 according to the embodiment is a method for obtaining the molded article 21 having a desired shape from a workpiece 10.

### Workpiece

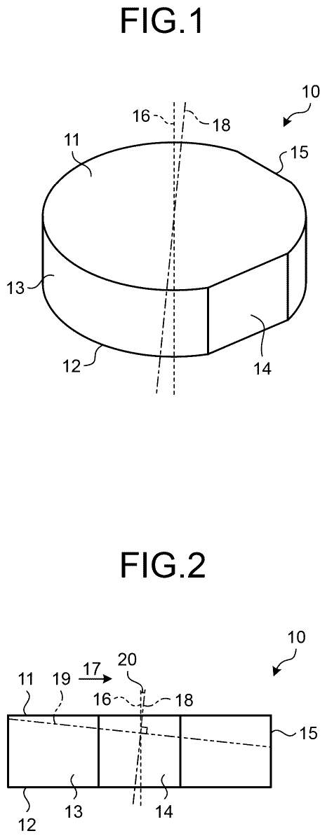

First, the configuration of the workpiece 10 to be processed by the method for manufacturing the molded article 21 according to the embodiment of the present disclosure will be described. FIG. 1 is a perspective view of the workpiece 10 to be processed by the method for manufacturing the molded article 21 according to the embodiment. FIG. 2 is a side view of the workpiece 10 illustrated in FIG. 1.

The workpiece 10 illustrated in FIGS. 1 and 2 includes silicon carbide (SiC), silicon (Si), lithium tantalate (LT), gallium nitride (GaN), gallium oxide (Ga2O3), or the like, and is an ingot having a cylindrical shape as a whole. In the embodiment, the workpiece 10 has a thickness of 350 μm. The workpiece 10 has a first surface 11, a second surface 12, a peripheral surface 13, a first orientation flat 14, and a second orientation flat 15.

The first surface 11 has a circular shape and is one end surface of the workpiece 10 having a cylindrical shape. The second surface 12 has a circular shape and is an end surface opposite to the first surface 11 of the workpiece 10 having a cylindrical shape. The second surface 12 corresponds to a bottom surface of the workpiece 10. The peripheral surface 13 is a surface continuous with an outer edge of the first surface 11 and an outer edge of the second surface 12.

The first orientation flat 14 is a plane formed on a part of the peripheral surface 13 to indicate a crystal orientation of the workpiece 10. The second orientation flat 15 is a plane formed on a part of the peripheral surface 13 to indicate the crystal orientation of the workpiece 10. The second orientation flat 15 is orthogonal to the first orientation flat 14. The first orientation flat 14 has a length that is longer than the length of the second orientation flat 15.

The workpiece 10 has a c-axis 18 inclined at an off angle 20 in an inclination direction 17 toward the second orientation flat 15 with respect to a perpendicular line 16 of the first surface 11 has and a c-plane 19 orthogonal to the c-axis 18. The inclination direction 17 from the perpendicular line 16 of the c-axis 18 is orthogonal to an extending direction of the second orientation flat 15 and parallel to the first orientation flat 14. The c-plane 19 is inclined at an off angle 20 with respect to the first surface 11 of the workpiece 10.

An infinite number of c-planes 19 are set in the workpiece 10 at a molecular level of the workpiece 10. In the embodiment, the off angle 20 of the workpiece 10 is set to 1°, 4°, or 6°. However, in the present disclosure, the off angle may be freely set within a range of 1° to 6°, for example. After the first surface 11 of the workpiece 10 is ground by a grinder, the first surface 11 is polished by a polisher to form a mirror surface.

### Method for Manufacturing Molded Article 21

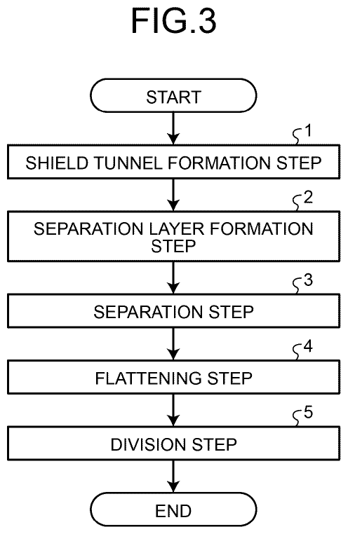

Next, the method for manufacturing the molded article 21 according to the embodiment of the present disclosure will be described. FIG. 3 is a flowchart illustrating a flow of the method for manufacturing the molded article 21 according to the embodiment. The method for manufacturing the molded article 21 includes a shield tunnel formation step 1, a separation layer formation step 2, a separation step 3, a flattening step 4, and a division step 5.

### Shield Tunnel Formation Step 1

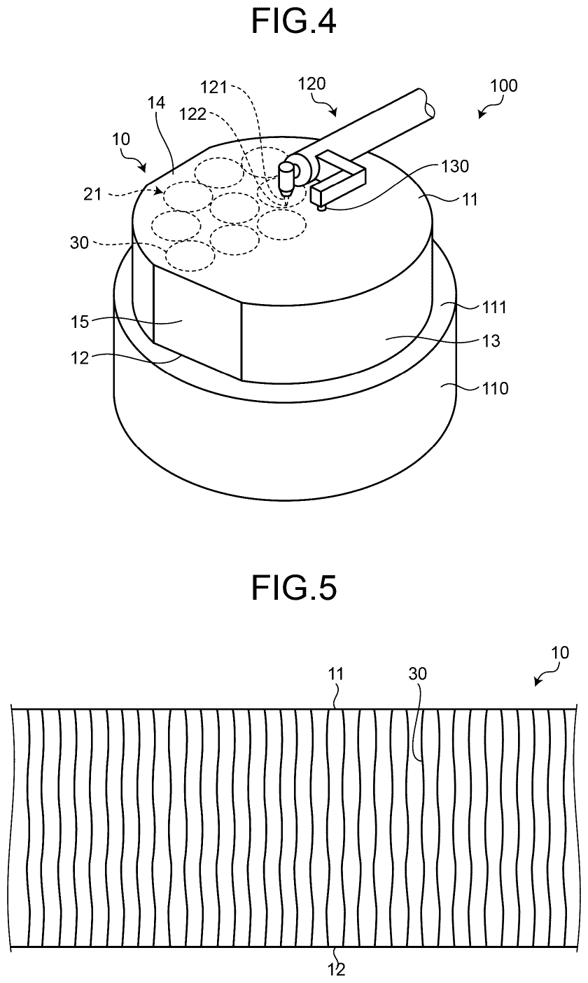

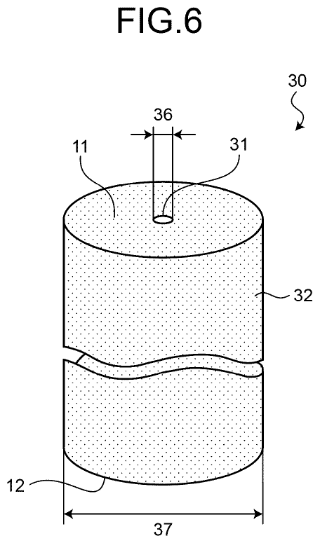

FIG. 4 is a perspective view illustrating a state of the shield tunnel formation step 1 illustrated in FIG. 3. FIG. 5 is an enlarged sectional view illustrating a part of the workpiece 10 after FIG. 4. FIG. 6 is a perspective view schematically illustrating a structure of a shield tunnel 30. The shield tunnel formation step 1 is a step of forming the shield tunnel 30 including a pore 31 extending from the first surface 11 of the workpiece 10 to a predetermined depth in a thickness direction of the workpiece 10 and a modified region 32 surrounding the pore 31 along a desired shape. The desired shape is a shape of the molded article 21 to be manufactured.

In the shield tunnel formation step 1 according to the embodiment, the shield tunnel 30 is formed in the workpiece 10 by a laser processing device 100 illustrated in FIG. 4. The laser processing device 100 includes a holding table 110, a laser beam irradiation unit 120, an imaging unit 130, and a moving unit (not illustrated) that relatively moves the holding table 110 and the laser beam irradiation unit 120.

The holding table 110 sucks and holds the workpiece 10 with a holding surface 111. The holding surface 111 has a disk shape including porous ceramic or the like, and is connected to a vacuum suction source via a vacuum suction path, for example. The laser beam irradiation unit 120 includes, for example, an oscillator that emits a laser beam, a concentrator that concentrates the laser beam toward the workpiece 10 held on the holding table 110, and various optical components that guide the laser beam from the oscillator to the concentrator.

In the shield tunnel formation step 1, first, the second surface 12 of the workpiece 10 is sucked and held on the holding surface 111 of the holding table 110. Next, the workpiece 10 and the concentrator of the laser beam irradiation unit 120 are aligned. Specifically, the holding table 110 is moved to a processing region below the laser beam irradiation unit 120 by a movement unit (not illustrated).

Next, an image of the workpiece 10 is captured by the imaging unit 130, and alignment for aligning a predetermined processing target position forming the shield tunnel 30 with an irradiator of the laser beam irradiation unit 120 is performed. After the irradiator of the laser beam irradiation unit 120 faces the first surface 11 of the workpiece 10 in a vertical direction, a concentration region 122 of a first laser beam 121 is positioned inside the workpiece 10. The first laser beam 121 is a laser beam having a wavelength transmissive to the workpiece 10.

In the shield tunnel formation step 1, next, the inside of the workpiece 10 is irradiated with the pulsed first laser beam 121 while the holding table 110 and the laser beam irradiation unit 120 are relatively moved so that the workpiece 10 is irradiated with the first laser beam 121 along a desired shape. In the embodiment, processing conditions with the first laser beam 121 are a wavelength of 1064 nm, an output of 0.25 W, a repetition frequency of 1 kHz, a feed speed of 25 mm/s, and the number of passes of seven.

The concentration region 122 positioned inside the workpiece 10 and the workpiece 10 move relatively, and are irradiated with the first laser beam 121 along a desired shape. Thus, the shield tunnel 30 extending from the first surface 11 of the workpiece 10 to a predetermined depth in the thickness direction of the workpiece 10 is formed. The shield tunnels 30 are formed at predetermined intervals along a desired shape by irradiation with the pulsed first laser beam 121.

As illustrated in FIG. 4, in the embodiment, the desired shape is a plurality of circular shapes. That is, the molded article 21 to be manufactured has a disk shape, and the plurality of molded articles 21 is manufactured in a horizontal direction.

Note that, as illustrated in FIG. 5, the shield tunnel 30 is desirably formed from the first surface 11 to the second surface 12, but for example, there may be partially a region in which the shield tunnel 30 is not formed in an upper portion, a lower portion, a central portion, or the like. The shield tunnel 30 is formed to have a depth at least equal to or larger than a depth of a thickness 22 (see FIG. 17) of the molded article 21 to be manufactured, and is preferably formed to have a depth of twice or more than twice the thickness 22 of the molded article 21 to be manufactured.

As illustrated in FIG. 6, the shield tunnel 30 includes the pore 31 extending from the first surface 11 to the second surface 12 of the workpiece 10, and the cylindrical modified region 32 surrounding the pore 31. The modified region 32 is an amorphous region. The inner diameter 36 of the pore 31 is about 1 μm, the outer diameter 37 of the modified region 32 is about 5 μm, and the interval between the modified regions 32 adjacent to each other is about 10 μm.

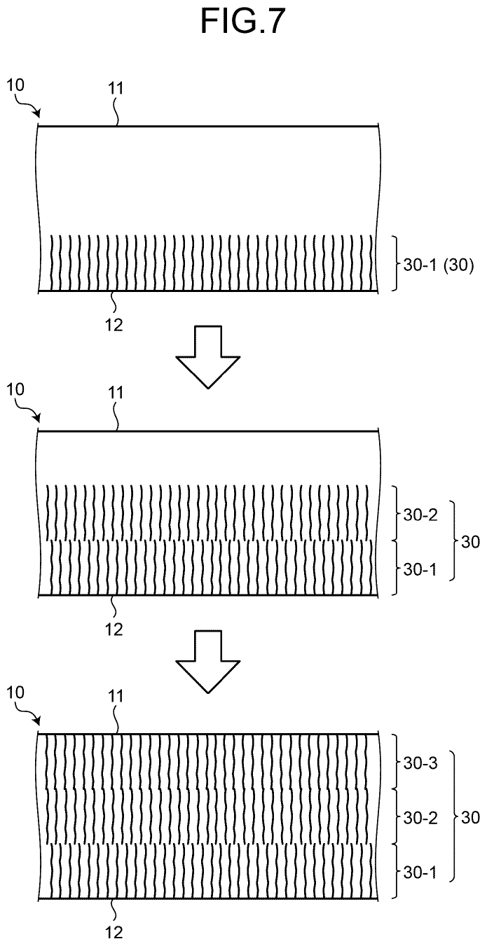

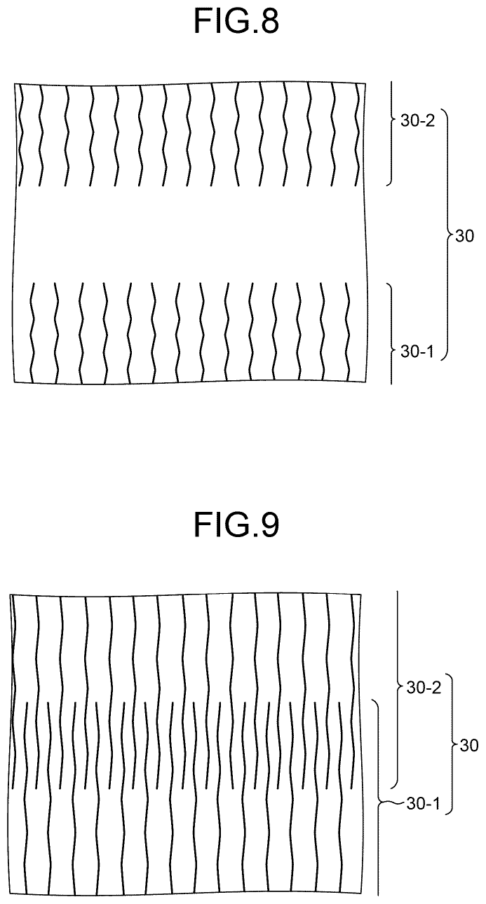

As described above, under the processing conditions according to the embodiment, the number of passes is seven. That is, a plurality of layers of shield tunnels 30 is formed. Here, a procedure for forming the plurality of layers of shield tunnels 30 will be described. FIG. 7 is a sectional view for describing the procedure of forming the plurality of layers of shield tunnels 30. FIG. 8 is a sectional view illustrating an example of an interlayer of the plurality of layers of shield tunnels 30. FIG. 9 is a sectional view illustrating another example of the interlayer of the plurality of layers of shield tunnels 30. Note that, in the following description, a case where the number of passes omitted and processing is performed in three passes will be described.

When the first laser beam 121 is emitted from the first surface 11 as in the embodiment, first, as illustrated in FIG. 7, in the first pass, a first shield tunnel 30-1 extending from the inside of the workpiece 10 to the second surface 12 is formed. Next, in the second pass, a second shield tunnel 30-2 is formed inside the workpiece 10 closer to the first surface 11 from the first shield tunnel 30-1. Then, in the third pass, a third shield tunnel 30-3 extending from the first surface 11 to the inside closer to the first surface 11 than the second shield tunnel 30-2 is formed.

At this time, the first shield tunnel 30-1 and the second shield tunnel 30-2 may be separated as illustrated in FIG. 8, or may partially overlap as illustrated in FIG. 9. Similarly, the second shield tunnel 30-2 and the third shield tunnel 30-3 may be separated or may partially overlap.

### Division Auxiliary Line Setting Step and Division Auxiliary Start Point Formation Step

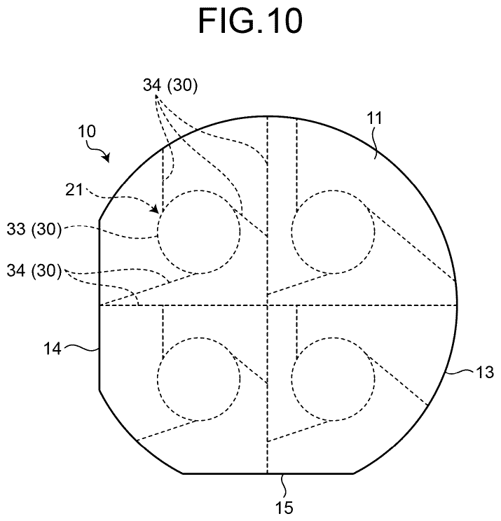

The shield tunnel formation step 1 preferably includes a division auxiliary line setting step and a division auxiliary start point formation step. FIG. 10 is a top view of the workpiece 10 for describing the division auxiliary line setting step and the division auxiliary start point formation step. The division auxiliary line setting step is a step of setting a division auxiliary line 34 between an outer peripheral edge of the workpiece 10 and a division line 33.

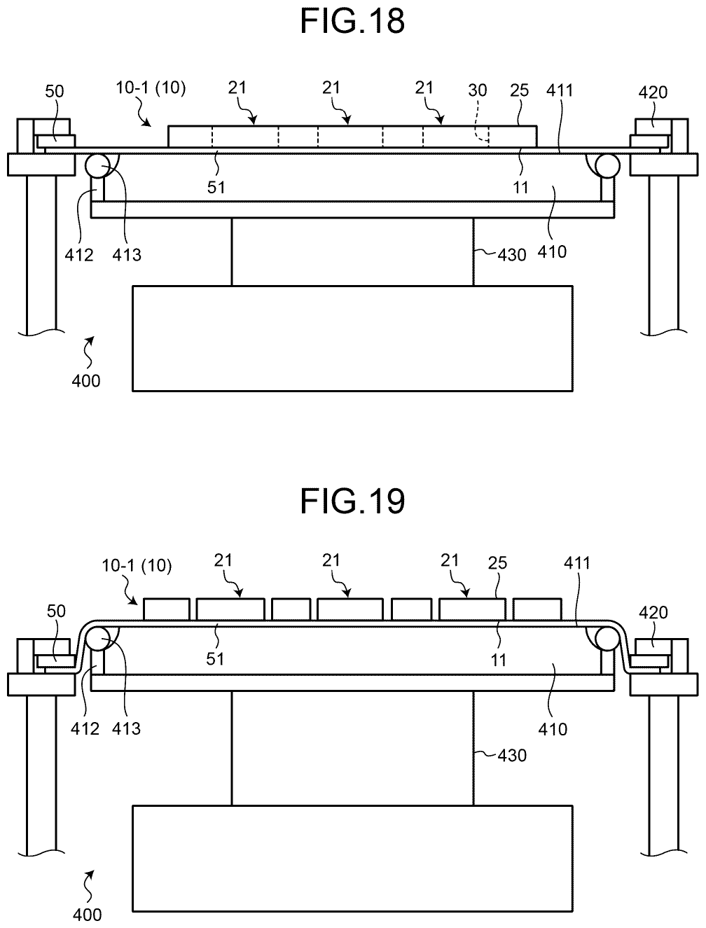

The division line 33 corresponds to a contour of the molded article 21, and corresponds to a boundary line for dividing the molded article 21 to be manufactured from a first workpiece 10-1 (see FIGS. 18 and 19 described later). The division auxiliary line 34 may be set between a predetermined position of the outer peripheral edge of the workpiece 10 and a different position without passing through the division line 33. The division auxiliary line 34 may be connected to the division line 33, but is preferably slightly separated.

The division auxiliary start point formation step is a step of forming the shield tunnel 30 including the pore 31 and the modified region 32 surrounding the pore 31 inside the workpiece 10 along the division auxiliary line 34. A procedure of the division auxiliary start point formation step is similar to the procedure of forming the shield tunnel 30 along the shape of the molded article 21. The division auxiliary start point formation step may be performed as a part of the shield tunnel formation step 1 as in the embodiment, or may be separately performed before or after the shield tunnel formation step 1.

When the shield tunnel 30 is formed along the shape of the molded article 21, the concentration region 122 of the first laser beam 121 having a wavelength transmissive to the workpiece 10 is positioned inside the workpiece 10, and the shield tunnel 30 is formed inside the workpiece 10 along the division line 33 by irradiating the workpiece with the first laser beam 121 along the division line 33. On the other hand, in the division auxiliary start point formation step, a concentration region of a third laser beam having a wavelength transmissive to the workpiece 10 is positioned inside the workpiece 10, and the shield tunnel 30 is formed inside the workpiece 10 along the division auxiliary line 34 by irradiating the workpiece 10 with the third laser beam along the division auxiliary line 34. Since a region other than the region to be the molded article 21 is divided into a plurality of regions by the division auxiliary start point formation step, the molded article 21 can be divided by expanding in the division step 5 described later.

Processing conditions by the third laser beam may be the same as or different from the processing conditions by the first laser beam 121. When the division auxiliary start point formation step is separately performed before or after the shield tunnel formation step 1, a laser processing device used in the division auxiliary start point formation step may be the same device as or a different device from the laser processing device 100 used in the shield tunnel formation step 1.

### Separation Layer Formation Step 2

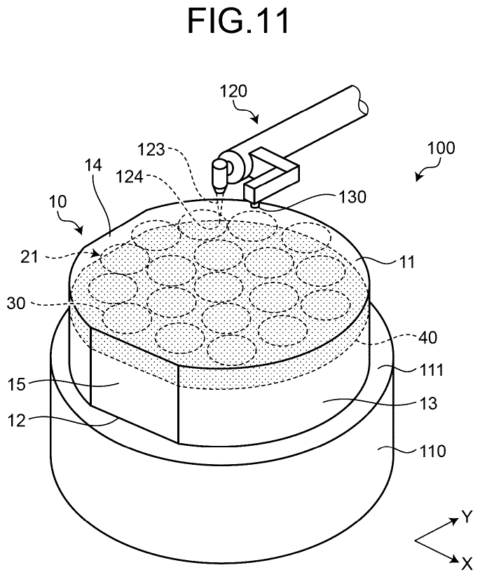

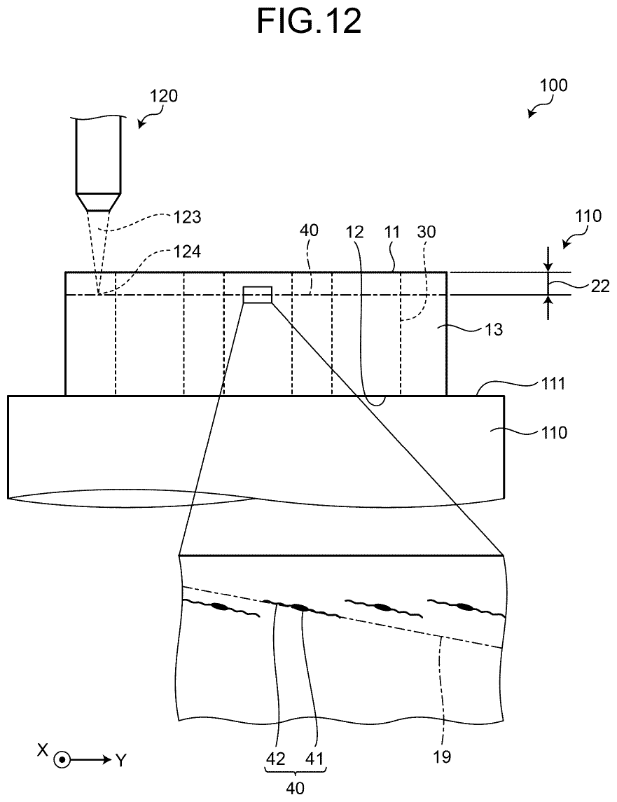

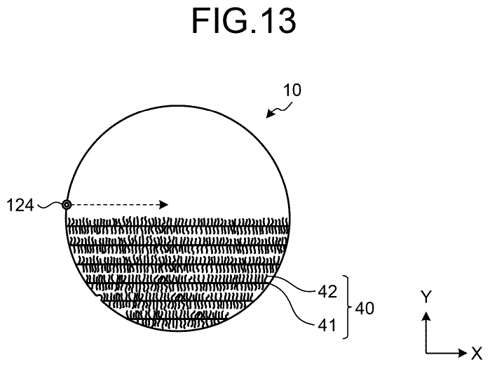

FIG. 11 is a perspective view illustrating a state of a separation layer formation step 2 illustrated in FIG. 3. FIG. 12 is a side view illustrating a state of the separation layer formation step 2 illustrated in FIG. 3 in a partial cross section. FIG. 13 is a top view of the workpiece 10 in FIGS. 11 and 12. The separation layer formation step 2 is a step of forming a separation layer 40 including a modified portion 41 parallel to the first surface 11 and a crack 42 extending from the modified portion 41. The separation layer formation step 2 is preferably performed after the shield tunnel formation step 1 is performed.

In the separation layer formation step 2 according to the embodiment, the separation layer 40 is formed in the workpiece 10 by the laser processing device 100 illustrated in FIG. 11. The laser processing device 100 used in the separation layer formation step 2 may be the same device as or a different device from the laser processing device 100 used in the shield tunnel formation step 1.

In the separation layer formation step 2, first, the second surface 12 of the workpiece 10 is sucked and held on the holding surface 111 of the holding table 110. Next, the workpiece 10 and the concentrator of the laser beam irradiation unit 120 are aligned. Specifically, the holding table 110 is moved to a processing region below the laser beam irradiation unit 120 by a movement unit (not illustrated). Note that, in a case where the processing is performed by the same device as the laser processing device 100 used in the shield tunnel formation step 1, the above procedure is omitted.

In the separation layer formation step 2, the second orientation flat 15 of the workpiece 10 and a processing feed direction (X-axis direction) are adjusted to be parallel. Next, a concentration point 124 of a second laser beam 123 is positioned at a depth corresponding to the thickness 22 (see FIG. 12) of the molded article 21 to be manufactured from the first surface 11 of the workpiece 10. The second laser beam 123 is a laser beam having a wavelength transmissive to the workpiece 10.

In the separation layer formation step 2, next, the concentrator of the laser beam irradiation unit 120 and the holding table 110 are relatively moved. That is, the concentration point 124 and the workpiece 10 are relatively moved, and the workpiece 10 is irradiated with the second laser beam 123. In the embodiment, the processing conditions with the second laser beam 123 are a wavelength of 1064 nm, an output of 1.5 W, a repetition frequency of 120 kHz, a feed speed of 785 mm/s, and an index of 250 μm to 400 μm.

The concentration point 124 positioned at a depth corresponding to the thickness 22 of the molded article 21 to be manufactured from the first surface 11 of the workpiece 10 and the workpiece 10 relatively move, and are irradiated with the second laser beam 123 along a direction parallel to the first surface 11. Thus, the modified portion 41 is formed along the direction parallel to the first surface 11. Then, the crack 42 extending from the modified portion 41 along the c-plane 19 is formed. In the embodiment, the crack 42 extends in an indexing direction (Y-axis direction). Thus, in the separation layer formation step 2, the separation layer 40 that include the modified portion 41 and the crack 42 formed along the c-plane 19 from the modified portion 41 is formed.

### Separation Step 3

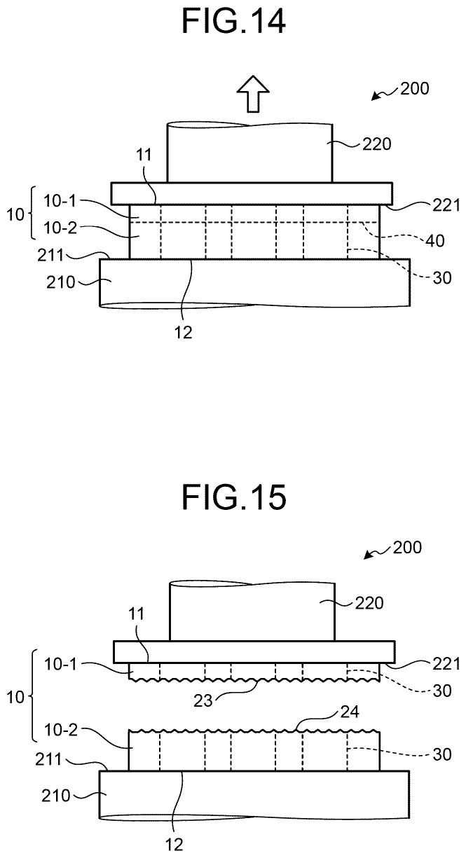

FIGS. 14 and 15 are side views illustrating a state of the separation step 3 illustrated in FIG. 3. The separation step 3 is performed after performing the shield tunnel formation step 1 and the separation layer formation step 2. The separation step 3 is a step of separating the workpiece 10 into the first workpiece 10-1 having the first surface 11 and a second workpiece 10-2 having the second surface 12 with the separation layer 40 as a start point.

In the separation step 3 according to the embodiment, the workpiece 10 is separated into the first workpiece 10-1 and the second workpiece 10-2 by a peeling device 200 illustrated in FIGS. 14 and 15. The peeling device 200 includes a holding table 210, a peeling unit 220, and a movement unit (not illustrated) that relatively moves the holding table 210 and the peeling unit 220.

The holding table 210 sucks and holds the second surface 12 of the workpiece 10 with a holding surface 211. The holding surface 111 has a disk shape including porous ceramic or the like, and is connected to a vacuum suction source via a vacuum suction path, for example. The peeling unit 220 sucks and holds the first surface 11 of the workpiece 10 with the holding surface 221 facing the holding surface 211 of the holding table 210. The holding surface 211 has a disk shape including porous ceramic or the like, and is connected to a vacuum suction source via a vacuum suction path, for example. The peeling unit 220 can be brought close to and separated from the holding table 210 by the movement unit (not illustrated).

In the separation step 3, first, as illustrated in FIG. 14, the second surface 12 of the workpiece 10 is sucked and held by the holding surface 211 of the holding table 210. In the separation step 3, next, the peeling unit 220 is brought close to the holding table 210, and the first surface 11 of the workpiece 10 is sucked and held by the holding surface 221.

In this state, as illustrated in FIG. 15, the peeling unit 220 is separated from the holding table 210. As a result, the workpiece 10 pulled up and down is separated with the separation layer 40 as an interface, and is separated into the first workpiece 10-1 having the first surface 11 and the second workpiece 10-2 having the second surface 12.

### Flattening Step 4

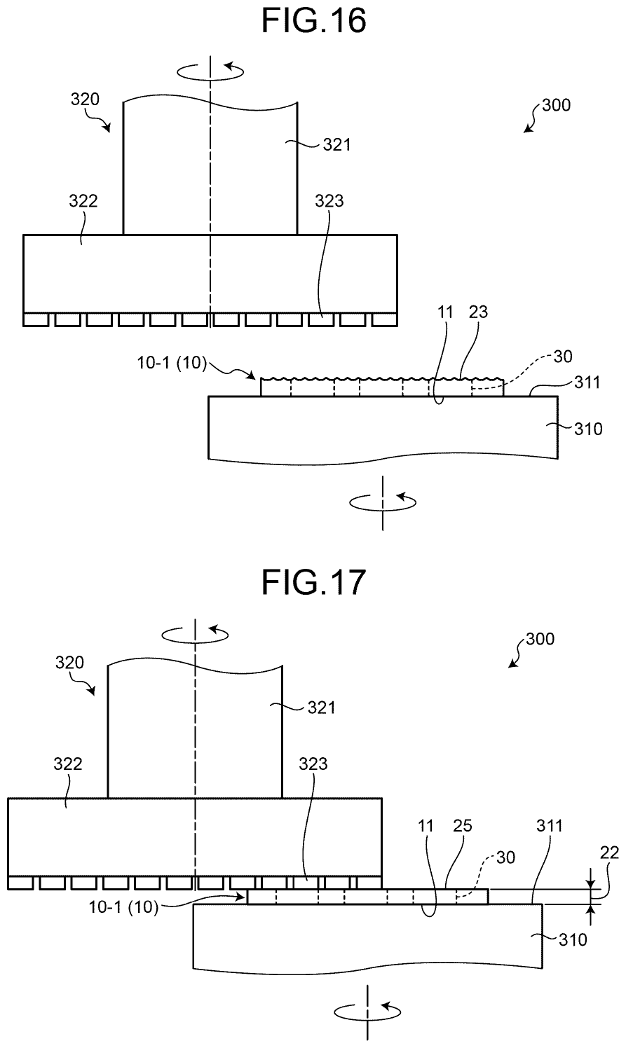

FIGS. 16 and 17 are side views illustrating a state of the flattening step 4 illustrated in FIG. 3 in a partial cross section. The flattening step 4 is a step of grinding or polishing a separation surface 23 of the first workpiece 10-1 and a separation surface 24 of the second workpiece 10-2 separated in the separation step 3 to flatten the separation surfaces 23 and 24.

In the flattening step 4 according to the embodiment, the separation surface 23 of the first workpiece 10-1 is ground and flattened by a grinding device 300 illustrated in FIGS. 16 and 17. The grinding device 300 includes a holding table 310, a grinding unit 320, a grinding liquid supply unit (not illustrated), and a movement unit (not illustrated) that relatively moves the holding table 310 and the grinding unit 320.

The holding table 310 sucks and holds the first surface 11 of the first workpiece 10-1 with a holding surface 311. The holding surface 311 has a disk shape including porous ceramic or the like, and is connected to a vacuum suction source via a vacuum suction path, for example. The grinding unit 320 includes a spindle 321 that is a rotary shaft member, a wheel base 322 attached to a lower end of the spindle 321, and a grinding wheel 323 attached to a lower surface of the wheel base 322. The spindle 321 and the wheel base 322 rotate about a rotation axis parallel to an axial center of the holding table 310.

In the flattening step 4, first, the first surface 11 of the first workpiece 10-1 is sucked and held on the holding surface 311 of the holding table 310. Next, the wheel base 322 is rotated about the axial center via the spindle 321 while the holding table 310 is rotated about the axial center. By supplying a grinding fluid to a processing point by the grinding fluid supply unit (not illustrated) and bringing the grinding wheel 323 of the wheel base 322 close to the holding table 310 at a predetermined feed speed, the separation surface 23 of the first workpiece 10-1 is ground by the grinding wheel 323 and thinned to the predetermined thickness 22 illustrated in FIG. 17. The predetermined thickness 22 is the thickness 22 of the molded article 21 to be manufactured.

In the above description, a case where the separation surface 23 of the first workpiece 10-1 is ground has been described, but a case where the separation surface 24 of the second workpiece 10-2 is ground can also be performed by a similar procedure. In this case, the first workpiece 10-1 is only required to be replaced with the second workpiece 10-2, the separation surface 23 is only required to be replaced with the separation surface 24, and the first surface 11 is only required to be replaced with the second surface 12.

### Division Step 5

FIGS. 18 and 19 are side views illustrating a state of a first example of the division step 5 illustrated in FIG. 3 in a partial cross section. The division step 5 is a step of dividing the molded article 21 from the first workpiece 10-1 by performing predetermined processing on the first workpiece 10-1 along the shield tunnel 30 formed along the desired shape.

In the division step 5 of the first example, the molded article 21 is divided from the first workpiece 10-1 along the shield tunnel 30 by applying an external force to the first workpiece 10-1 by an expansion device 400 illustrated in FIGS. 18 and 19. The expansion device 400 includes a holding table 410, a clamp member 420, and a lift unit 430.

The holding table 410 sucks and holds the first surface 11 of the first workpiece 10-1 with a holding surface 411. The holding surface 411 has a disk shape including porous ceramic or the like, and is connected to a vacuum suction source via a vacuum suction path, for example. A cylindrical abutment member 412 provided coaxially on an outer periphery of the holding table 410 is provided around the holding table 410. A roller member 413 is rotatably provided at an upper end of the abutment member 412 on the same plane as or slightly above the holding surface 411 of the holding table 410.

In the division step 5 of the first example, first, an expandable tape 51 is stuck to the grinding surface 25 and an annular frame 50 of the first workpiece 10-1 ground or polished in the flattening step 4. The frame 50 includes metal or resin, and has an annular plate shape having an opening larger than an outer diameter of the first workpiece 10-1. The expandable tape 51 has, for example, a sheet shape including a base material layer including a synthetic resin having an expanding property and an adhesive layer laminated on the base material layer and including a synthetic resin having an expanding property and adhesiveness.

The expandable tape 51 is, for example, stuck to the first surface 11 of the first workpiece 10-1 and the annular frame 50, and then cut into such a shape and size as to cover the opening of the frame 50. The first workpiece 10-1 is fixed to the frame 50 and the expandable tape 51 by being positioned at a predetermined position of the opening of the frame 50 and sticking the first surface 11 to the expandable tape 51.

As illustrated in FIG. 18, in the division step 5, next, the first surface 11 of the first workpiece 10-1 is placed on the holding surface 411 of the holding table 410 via the expandable tape 51, and an outer peripheral portion of the frame 50 is fixed by the clamp member 420. At this time, the roller member 413 abuts on the expandable tape 51 between an inner edge of the frame 50 and an outer edge of the first workpiece 10-1.

As illustrated in FIG. 19, in the division step 5, next, the holding table 410 and the abutment member 412 are integrally raised by the lift unit 430. At this time, since the outer peripheral portion of the expandable tape 51 is fixed by the clamp member 420 via the frame 50, a portion between the inner edge of the frame 50 and the outer edge of the first workpiece 10-1 is expanded in a plane direction. Furthermore, the roller member 413 provided at the upper end of the abutment member 412 alleviates friction with the expandable tape 51.

In the division step 5, the expansion of the expandable tape 51 results in a radial tensile force acting on the expandable tape 51. When the radial tensile force acts on the expandable tape 51, as illustrated in FIGS. 18 and 19, the first workpiece 10-1 to which the expandable tape 51 is stuck is divided with the shield tunnel 30 as a fracture origin, and the molded article 21 is divided into individual pieces.

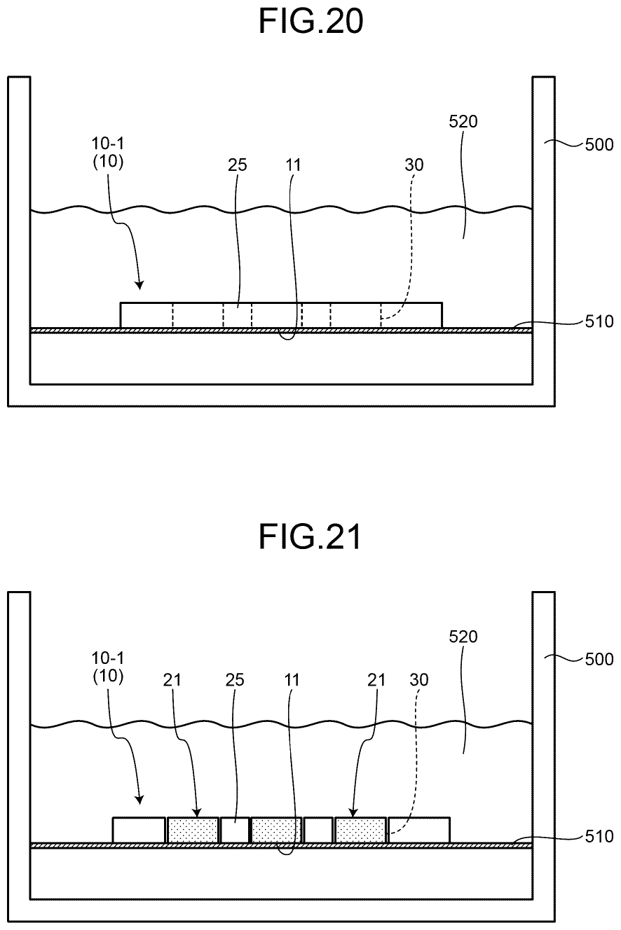

FIGS. 20 and 21 are side views illustrating a state of a second example of the division step 5 illustrated in FIG. 3 in a partial cross section. In the division step 5 of the second example, the molded article 21 is divided from the first workpiece 10-1 along the shield tunnel 30 by etching the first workpiece 10-1 with an etching solution 520.

In the division step 5 of the second example, as illustrated in FIGS. 20 and 21, by immersing the first workpiece 10-1 in a solution tank 500 that stores the etching solution 520 for a predetermined time, the first workpiece 10-1 is fractured along the shield tunnel 30 to divide the molded article 21 into individual pieces. At this time, it is preferable to place the first surface 11 of the first workpiece 10-1 on a placement net 510 provided at a position at a predetermined height from a bottom surface of the solution tank 500. When the etching solution 520 erodes along the shield tunnel 30 from the first surface 11 and the grinding surface 25, the first workpiece 10-1 corrodes and fractures along the shield tunnel 30.

The division step 5 is not limited to the method described in the first example and the second example, and may be performed simultaneously with the flattening step 4, for example. That is, in the division step 5, the separation surface 23 of the first workpiece 10-1 may be flattened by grinding or polishing the separation surface 23, and an external force may be applied to the first workpiece 10-1 to divide the molded article 21 from the first workpiece 10-1. In this case, the molded article 21 is divided with the shield tunnel 30 as a fracture origin by a grinding stress acting via the grinding wheel 323, and is divided into individual pieces.

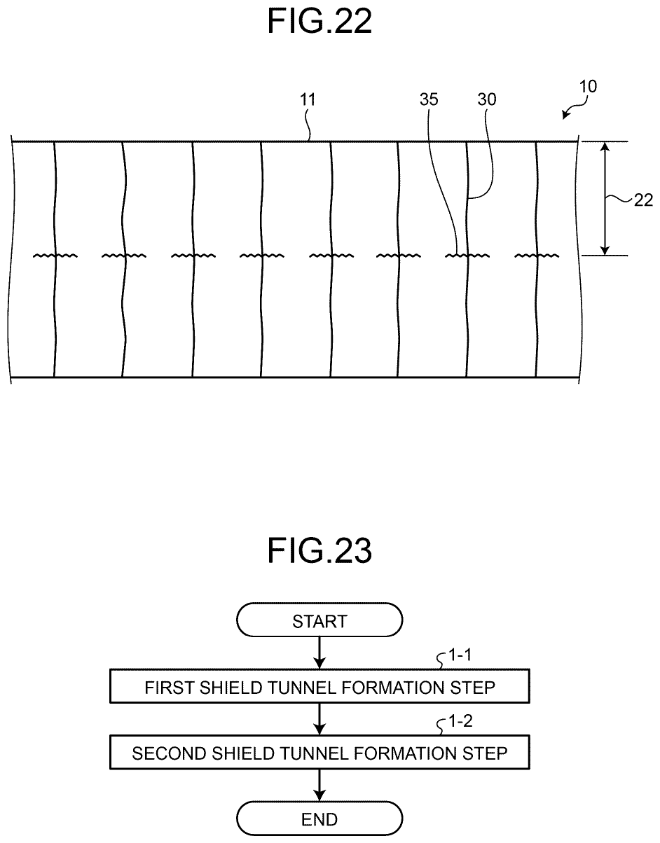

Note that, in a case where the division step 5 is performed by expanding as illustrated in FIGS. 19 and 20, it is necessary to form the shield tunnel 30 along the division auxiliary line 34 in the shield tunnel formation step 1. In a case where the division step 5 is performed by the etching solution or the grinding stress illustrated in FIGS. 21 and 22, the division auxiliary start point formation step is not required to be performed.

When the division step 5 ends, a whole process of the flowchart illustrated in FIG. 3 ends. Thereafter, the process of the flowchart illustrated in FIG. 3 is repeatedly performed until a predetermined number of molded articles 21 are manufactured from the workpiece 10. When the shield tunnel 30 corresponding to the thickness of the molded article 21 to be manufactured has already been formed, the shield tunnel formation step 1 is omitted, and the process from the separation layer formation step 2 to the division step 5 is repeatedly performed. A workpiece treated as the next workpiece 10 is the second workpiece 10-2 separated in the separation step 3, and a first surface treated as the first surface 11 is a surface obtained after the separation surface 24 is ground in the flattening step 4. After the first workpiece 10-1 is separated in the separation step 3, while the flattening step 4 and the division step 5 are performed on the first workpiece 10-1, the separation layer formation step 2 and the shield tunnel formation step 1 may be simultaneously performed with the second workpiece 10-2 as a new workpiece 10.

Note that the holding tables 110, 210, and 310 may be used in common at least in preceding and subsequent steps. For example, the workpiece 10 in which the shield tunnel 30 and the separation layer 40 are formed by the laser beam irradiation unit 120 may be conveyed on the holding table 110 to a position facing the peeling unit 220. The second workpiece 10-2 after the first workpiece 10-1 is separated by the peeling unit 220 may be conveyed on the holding table 210 to a position facing the grinding unit 320.

### First Modification

A method for manufacturing a molded article 21 according to a first modification of the present disclosure will be described with reference to the drawings. In the method for manufacturing the molded article 21 according to the first modification, an intensity distribution of the first laser beam 121 with which the inside of the workpiece 10 is irradiated is controlled in the shield tunnel formation step 1.

FIG. 22 is a sectional view of the workpiece 10 for describing the shield tunnel formation step 1 according to the first modification. In the shield tunnel formation step 1 according to the first modification, by irradiating the workpiece 10 with the first laser beam 121 having the controlled intensity distribution, the shield tunnel 30 including the pore 31 and the modified region 32 surrounding the pore 31 is formed inside the workpiece 10, and the crack 35 parallel to the first surface 11 is formed at a depth corresponding to the thickness 22 of the molded article 21 to be manufactured.

The intensity distribution of the first laser beam 121 includes an intensity distribution in the thickness direction of the workpiece 10. The intensity distribution can be controlled, for example, by a pattern adjustment in a liquid crystal on silicon (LCOS). When aberration is formed by providing a glass at a rear stage of the concentrator of the laser beam irradiation unit 120, the intensity distribution may be controlled by changing the thickness of the glass.

Usually, when the shield tunnel 30 is formed, it is preferable to form the concentration region 122 having a longitudinal direction in the thickness direction of the workpiece 10 and to irradiate the workpiece 10 with the first laser beam 121 so that the intensity is uniform in the thickness direction. In the shield tunnel formation step 1 according to a second modification, the intensity is increased at a depth corresponding to the thickness 22 of the molded article 21 to be manufactured to promote the extension of the crack 35 at the depth.

### Second Modification

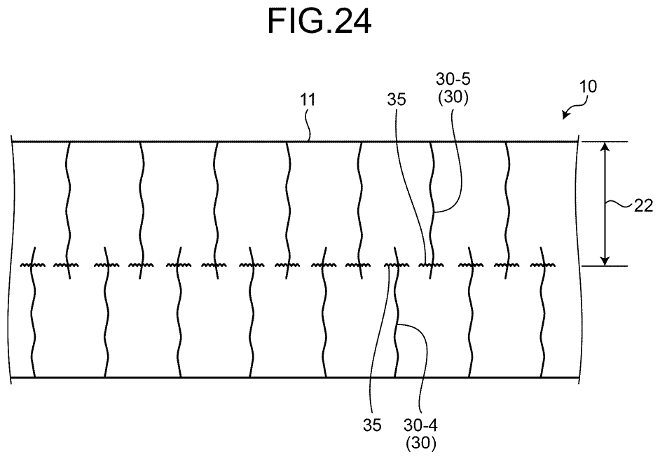

A method for manufacturing a molded article 21 according to the second modification of the present disclosure will be described with reference to the drawings. FIG. 23 is a flowchart illustrating a flow of the shield tunnel formation step 1 according to the second modification. In the method for manufacturing the molded article 21 according to the second modification, the shield tunnel formation step 1 includes a first shield tunnel formation step 1-1 and a second shield tunnel formation step 1-2.

FIG. 24 is a sectional view of the workpiece 10 for describing the shield tunnel formation step 1 according to the second modification. In the shield tunnel formation step 1 according to the second modification, a first shield tunnel 30-4 formed on the second surface 12 and a second shield tunnel 30-5 formed closer to the first surface 11 than the first shield tunnel 30-4 are formed at different positions in the thickness direction of the workpiece 10.

First, in the first shield tunnel formation step 1-1, the concentration region 122 of the first laser beam 121 having a wavelength transmissive to the workpiece 10 is positioned in a first region inside the workpiece 10, and the first laser beam 121 is emitted along a desired shape to form the first shield tunnel 30-4 along the desired shape inside the workpiece 10. Next, in the second shield tunnel formation step 1-2, the concentration region 122 of the first laser beam 121 is positioned in a second region inside the workpiece 10, and the first laser beam 121 is emitted along a desired shape to form the second shield tunnel 30-5 inside the workpiece 10 along the desired shape.

The first region is a predetermined region extending in the thickness direction inside the workpiece 10. The second region is a predetermined region extending in the thickness direction inside the workpiece 10, and is a region located at a different position in the thickness direction from the position of the first region. In the embodiment, the first shield tunnel 30-4 extends from the second surface 12 to the inside of the workpiece 10. The second shield tunnel 30-5 extends from the inside of the workpiece 10 to the first surface 11. In the embodiment illustrated in FIG. 24, the first shield tunnel 30-4 and the second shield tunnel 30-5 are alternately formed along a desired shape in plan view. However, the first shield tunnel and the second shield tunnel preferably overlap each other, and the first shield tunnel and the second shield tunnel more preferably overlap each other at the same position.

The first shield tunnel 30-4 and the second shield tunnel 30-5 are set to overlap each other by a predetermined amount or more along the thickness direction at a depth corresponding to the thickness 22 of the molded article 21 to be manufactured. The predetermined amount is preferably 70% or more, more preferably 85% or more of a range of the concentration region. Thus, the crack 35 parallel to the first surface 11 can be formed at a depth corresponding to the thickness 22 of the molded article 21 to be manufactured.

As described above, in the method for manufacturing the molded article 21 according to the embodiment and each modification, the shield tunnel 30 is formed over a plurality of sheets in the thickness direction along an outer shape of the shape in plan view of the molded article 21 to be manufactured, and then the separation layer 40 for peeling a substrate one by one in the thickness direction is formed. Therefore, it is not necessary to irradiate every substrate with the first laser beam 121 for manufacturing the molded article 21, and thus, the molded article 21 having a desired shape can be obtained in a short time.

Furthermore, as illustrated in the first modification and the second modification, in the shield tunnel formation step 1, by adjusting the irradiation with the first laser beam 121, the crack 35 parallel to the first surface 11 can be formed at a depth corresponding to the thickness 22 of the molded article 21 to be manufactured. It is therefore possible to assist the formation of the separation layer 40 in the separation layer formation step 2.

Note that the present invention is not limited to the above embodiment. That is, various modifications can be made without departing from the gist of the present invention.

For example, incident surfaces of the first laser beam 121 in the shield tunnel formation step 1 and the second laser beam 123 in the separation layer formation step 2 are not limited. That is, in the shield tunnel formation step 1 and the separation layer formation step 2, the first laser beam 121 and the second laser beam 123 may be emitted from the same surface (first surface 11) as in the embodiment, or the first laser beam 121 and the second laser beam 123 may be emitted from different surfaces.

In the separation step 3, the separation layer 40 may be peeled off as a start point by applying an ultrasonic wave, or the separation layer 40 may be peeled off as a start point by applying an external force by inserting a wedge from a peripheral surface of the workpiece 10. After the application of the ultrasonic wave, the first surface 11 and the second surface 12 may be separated by being sucked and held as in the embodiment to be peeled off. When the separation layer 40 is peeled off as a start point by applying an ultrasonic wave, it is preferable to perform the separation step at the same time as the division step 5 of dividing the molded article 21 with the shield tunnel 30 as a start point. In this case, the flattening step 4 is performed after the separation step 3 and the division step 5 to grind or polish the separation surfaces 23 and 24 of the already divided molded article 21.

A tape may be stuck to the first surface 11 before the separation step 3. Furthermore, before the shield tunnel formation step 1 and the separation layer formation step 2, a tape may be stuck to the first surface 11, and the first laser beam 121 and the second laser beam 123 may be emitted through the tape. In the separation step 3, since the tape is stuck to the first workpiece 10-1, it is possible to grind or polish in the flattening step 4 in a state of being fixed to the tape, and it is possible to suppress disassembly at the time of division. The tape may be, for example, the expandable tape 51 used in the first example of the division step 5.

According to the present disclosure, it is possible to obtain a molded article having a desired shape in a short time.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A method for manufacturing a molded article to obtain the molded article having a desired shape from a workpiece having a first surface and a second surface opposite to the first surface, the method comprising:
forming, along the desired shape, a shield tunnel including a pore extending from the first surface of the workpiece to a predetermined depth in a thickness direction of the workpiece and a modified region surrounding the pore by positioning a concentration region of a first laser beam having a wavelength transmissive to the workpiece inside the workpiece and irradiating the workpiece with the first laser beam along the desired shape;
forming a separation layer including a modified portion parallel to the first surface and a crack extending from the modified portion by positioning a concentration point of a second laser beam having a wavelength transmissive to the workpiece at a depth corresponding to a thickness of the molded article to be manufactured from the first surface, relatively moving the concentration point and the workpiece, and irradiating the workpiece with the second laser beam;
separating the workpiece into a first workpiece having the first surface and a second workpiece having the second surface with the separation layer as a start point after the forming the shield tunnel and the forming the separation layer; and
dividing the molded article from the first workpiece along the shield tunnel formed along the desired shape by performing predetermined processing on the first workpiece.

2. The method for manufacturing a molded article according to claim 1, wherein
the forming the separation layer is performed after the shield tunnel is formed.

3. The method for manufacturing a molded article according to claim 1, the method further comprising flattening a separation surface of the first workpiece and a separation surface of the second workpiece, obtained by the separating the workpiece, by grinding or polishing the separation surface.

4. The method for manufacturing a molded article according to claim 1, wherein the dividing the molded article includes
flattening the separation surface by grinding or polishing the separation surface of the first workpiece, and
applying an external force to the first workpiece to divide the molded article from the first workpiece.

5. The method for manufacturing a molded article according to claim 1, wherein the dividing the molded article includes dividing the molded article from the first workpiece along the shield tunnel by applying the external force to the first workpiece.

6. The method for manufacturing a molded article according to claim 1, wherein the dividing the molded article includes dividing the molded article from the first workpiece along the shield tunnel by etching the first workpiece with an etchant.

7. The method for manufacturing a molded article according to claim 1, wherein the forming the shield tunnel includes
setting a division auxiliary line between an outer peripheral edge of the workpiece and the molded article, and
forming a shield tunnel including a pore and the modified region surrounding the pore inside the workpiece along the division auxiliary line by positioning a concentration region of a third laser beam having a wavelength transmissive to the workpiece inside the workpiece and irradiating the workpiece with the third laser beam along the division auxiliary line.

8. The method for manufacturing a molded article according to claim 1, wherein the forming the shield tunnel includes
by controlling an intensity distribution of the first laser beam with which an inside of the workpiece is irradiated, and irradiating the workpiece with the first laser beam having the intensity distribution controlled,
forming a shield tunnel including a pore and a modified region surrounding the pore inside the workpiece, and
forming a crack parallel to the first surface at the depth corresponding to the thickness of the molded article to be manufactured.

9. The method for manufacturing a molded article according to claim 1, wherein
the forming the shield tunnel includes
forming, along the desired shape, a first shield tunnel including a pore extending along a thickness direction of the workpiece and a modified region surrounding the pore by positioning a concentration region of the first laser beam in a first region inside the workpiece and irradiating the workpiece with the first laser beam along the desired shape, and
forming, along the desired shape, a second shield tunnel including a pore extending along the thickness direction of the workpiece and the modified region surrounding the pore by positioning a concentration region of the first laser beam in a second region located at a different position in the thickness direction from a position of the first region inside the workpiece and irradiating the workpiece with the first laser beam along the desired shape, and
the first shield tunnel and the second shield tunnel are set to overlap each other by a predetermined amount or more in the thickness direction at the depth corresponding to the thickness of the molded article to be manufactured, and a crack parallel to the first surface is formed at the depth corresponding to the thickness of the molded article to be manufactured.
